(19) United States
(12) Patent Application Publication
(10) Pub. No.: US 2011/0099227 A1
(43) Pub. Date: Apr. 28, 2011

(54) COMMUNICATION APPLICATION WITH STEADY-STATE CONFERENCING

(76) Inventors: Jeffrey J. Walls, Fort Collins, CO (US); Karen E. Thayer, Fort Collins, CO (US); Byron A. Alcorn, Fort Collins, CO (US)

(21) Appl. No.: 12/606,940

(22) Filed: Oct. 27, 2009

(51) Int. Cl. G06F 15/173; G06F 15/16

(52) U.S. Cl. 709/204; 709/224

(57) ABSTRACT

In at least some embodiments, a computer system includes a processor and a network interface coupled to the processor. The computer system also includes a system memory coupled to the processor. The system memory stores a communication application having a steady-state conferencing module and a network manager module. The network manager module, when executed, monitors network changes. The steady-state conferencing module, when executed, maintains a steady-state conferencing user interface while network changes detected by the network manager module are handled.

### CROSS-REFERENCE TO RELATED APPLICATIONS

The present application may be related to each of the following applications: U.S. application Ser. No. 12/551,273, filed Aug. 31, 2009, and entitled “COMMUNICATION APPLICATION”; U.S. application Ser. No. ______ (Atty. Docket No. 2774-14600), filed ______, and entitled “MEDIA PIPELINE FOR A CONFERENCING SESSION”; and U.S. application Ser. No. ______ (Atty. Docket No. 2774-14700), filed ______, and entitled “ACOUSTIC ECHO CANCELLATION (AEC) WITH CONFERENCING ENVIRONMENT TEMPLATES (CETs)”, all hereby incorporated herein by reference in their entirety.

### BACKGROUND

Remote conferencing sessions between different computing devices are usually dependent on at least one intermediary network to convey information back and forth. If a conference client cannot connect to the intermediary network, a conferencing session cannot be initiated. Likewise, if a conference client loses its connection to the intermediary network (i.e., a “dropout”), a conferencing session that has already been initiated will be interrupted. In addition to dropouts, other network changes that may interrupt a conferencing session include a conference client changing its Internet Protocol (IP) address.

### BRIEF DESCRIPTION OF THE DRAWINGS

For a detailed description of exemplary embodiments of the invention, reference will now be made to the accompanying drawings in which:

FIG. 1 illustrates a system in accordance with embodiments of the disclosure;

FIG. 2 illustrates various software components of a communication application in accordance with an embodiment of the disclosure;

FIG. 3 illustrates a communication technique between two endpoints in accordance with an embodiment of the disclosure; and

FIG. 4 illustrates a method in accordance with embodiments of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the invention are directed to techniques for remote conferencing via at least one intermediary network. In at least some embodiments, a communication application is provided to handle network changes without interrupting a conference client experience. In other words, the communication application presents a “steady-state conferencing” user interface to a conference client. As used herein, “steady-state conferencing” refers to a conferencing session technique in which presentation of a conferencing user interface is maintained even if network changes temporarily interrupt a media exchange during the conferencing session. As needed, the steady-state conferencing user interface enters a waiting state while network changes are handled. In some embodiments, the handling of network changes is transparent to a conference client. In alternative embodiments, the steady-state conferencing user interface notifies the conference client regarding network changes and perhaps the expected wait time for recovery. In either case, the presentation of the steady-state conferencing user interface to the conference client is maintained with no subsequent login process (or other conference client actions) required to restart or continue media exchanges for a remote conferencing session that has been interrupted by network changes.

Examples of network changes that need to be handled by the communication application include “dropouts” (when all connections to an intermediary network are lost) and Internet Protocol (IP) address updates. More specifically, some computing device (e.g., mobile devices) may be configured to enable and disable networking frequently to save power, which results in IP address changes. Further, some computing devices are assigned “roaming” IP addresses to avoid using the same IP address more than once. Further, some computing devices employ a Dynamic Host Configuration Protocol (DHCP) configuration that results in IP address changes. Further, some IPv6-based network adapters are configured to periodically assign new IP addresses. Further, a computing device may have a plurality of Network Interface Cards (NICs), where each NIC is assigned one or more IP addresses (IPv4 or IPv6). Thus, the “in use” IP address is subject to change. As used herein, an “in use” IP address refers to an IP address that is bound to a networking interface for use by the communication application. A computer system may have a plurality of IP address that are configured and active, but only one at a time is bound for use by the communication application (e.g., for a peer-to-peer communication session).

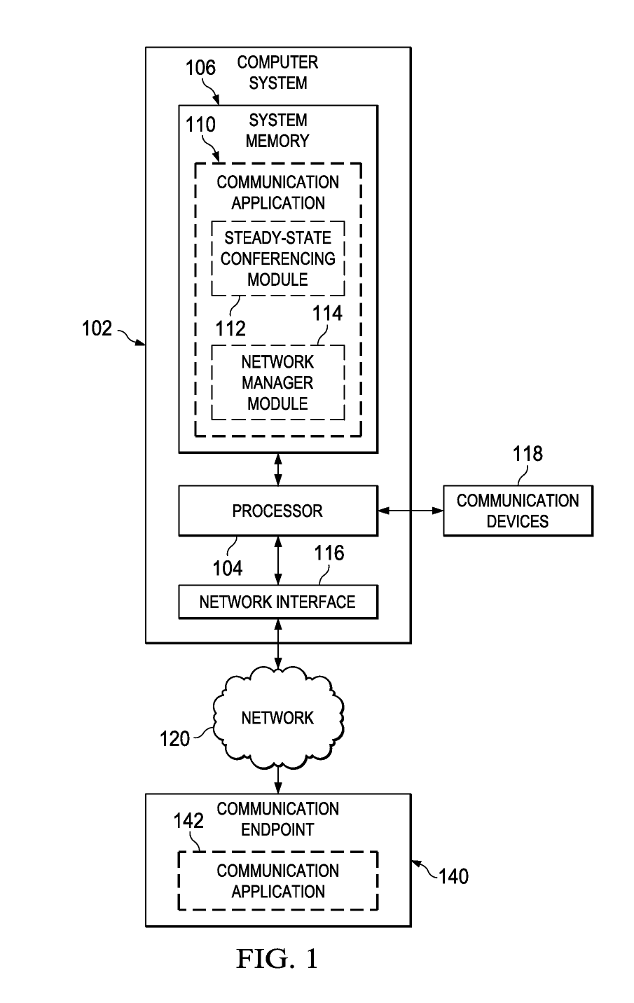

FIG. 1 illustrates a system 100 in accordance with embodiments of the disclosure. As shown in FIG. 1, the system 100 comprises a computer system 102 coupled to a communication endpoint 140 via a network 120. The computer system 102 is representative of a desktop computer, a laptop computer, a “netbook”, a smart phone, a personal digital assistant (PDA), or other electronic devices. Although only one communication endpoint 140 is shown, it should be understood that the computer system 102 may be coupled to a plurality of communication endpoints via the network 120. Further, it should be understood, that the computer system 102 is itself a communication endpoint. As used herein, a “communication endpoint” refers to an electronic device that is capable of running a communication application and supporting a remote conferencing session.

In accordance with embodiments, the computer system 102 and communication endpoints (e.g., the communication endpoint 140) employ respective communication applications 110 and 142 to facilitate efficient remote conferencing sessions. As shown, the communication application 110 comprises a steady-state conferencing module 112 and a network manager module 114. Although not required, the communication application 142 may comprise the same modules as the communication application 110. Various operations related to the steady-state conferencing module 112 and a network manager module 114 will later be described.

As shown in FIG. 1, the computer system 102 comprises a processor 104 coupled to a system memory 106 that stores the communication application 110. In accordance with embodiments, the processor 104 may correspond to at least one of a variety of semiconductor devices such as microprocessors, central processing units (CPUs), microcontrollers, main processing units (MPUs), digital signal processors (DSPs), advanced reduced instruction set computing (RISC) machines, ARM processors, application specific integrated circuits (ASICs), field programmable gate arrays (FPGAs) or other processing devices. In operation, the processor 104 performs a set of predetermined functions based on data/instructions stored in or accessible to the processor 104. In at least some embodiments, the processor 104 accesses the system memory 106 to obtain data/instructions for the predetermined operations. The system memory 106 is sometimes referred to as a computer-readable storage medium and may comprise volatile memory (e.g., Random Access Memory), non-volatile memory (e.g., a hard drive, a flash drive, an optical disk storage, etc.), or both.

To support a remote conferencing session, the computer system 102 comprises communication devices 118 coupled to the processor 104. The communication devices may be built-in devices and/or peripheral devices of the computer system 102. As an example, the communication devices 118 may correspond to various input devices and/or output devices such as a microphone, a video camera (e.g., a web-cam), speakers, a video monitor (e.g., a liquid crystal display), a keyboard, a keypad, a mouse, or other devices that provide a user interface for communications. Each communication endpoint (e.g., the communication endpoint 140) also may include such communication devices.

To enable remote conferencing sessions with communication endpoints coupled to the network 120, the computer system 102 further comprises a network interface 116 coupled to the processor 104. The network interface 116 may take the form of modems, modem banks, Ethernet cards, Universal Serial Bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, or other network interfaces. In conjunction with execution of the communication application 110 by the processor 104, the network interface 116 enables initiation and maintenance of a remote conferencing session between the computer system 102 and a communication endpoint.

In accordance with at least some embodiments, execution of the steady-state conferencing module 112 (e.g., by the processor 104) causes presentation of a steady-state conferencing user interface to a conference client at the computer system 102. As an example, the steady-state conferencing user interface may be presented to the conference client using an LCD or other monitor included with the communication devices 118. In accordance with at least some embodiments, the steady-state conferencing user interface is presented to the conference client at the computer system 102 once a login process to the communication application 110 has been successfully completed. Alternatively, the steady-state conferencing user interface is presented to the conference client at the computer system 102 once a remote conferencing session begins (by selection and acceptance of participating conference clients).

Meanwhile, execution of the network manager module 114 (e.g., by the processor 104) enables network changes to be detected and handled without visually affecting the presentation of the steady-state conferencing user interface. There are various ways in which network changes may be detected by the network manager module 114. For example, the network manager module 114 may cause the processor 104 to monitor remote network changes (e.g., dropouts and IP address changes) via the network interface 116. These remote network changes are received from remote clients (e.g., at different communication endpoints) associated with the communication application 110. Further, the network manager module 114 may cause the processor 104 to monitor local network changes at the computer system 102 and to selectively broadcast these local network updates via the network interface 116 to remote clients associated with the communication application 110.

In at least some embodiments, network changes are detected if there is a change to an IP address table maintained by the computer system 102. The IP address table may contain multiple IP addresses. If such case, a preferred network interface and its associated IP address are selected as the “in use” IP address. For example, heuristics information may be used to determine a preferred network interface. Detected network changes are handled by determining if the “in use” IP address is still valid and, if necessary, notifying observers (e.g., various modules of the communication application 110) of the network changes. If a change is made, each observer is notified and handles the change appropriately. In at least some embodiments, gateway servers are observers of network changes. In such case, when a new IP address is detected, the gateway servers resend presence information to all of the contacts in the user-specific contact list maintained by the communication application 110.

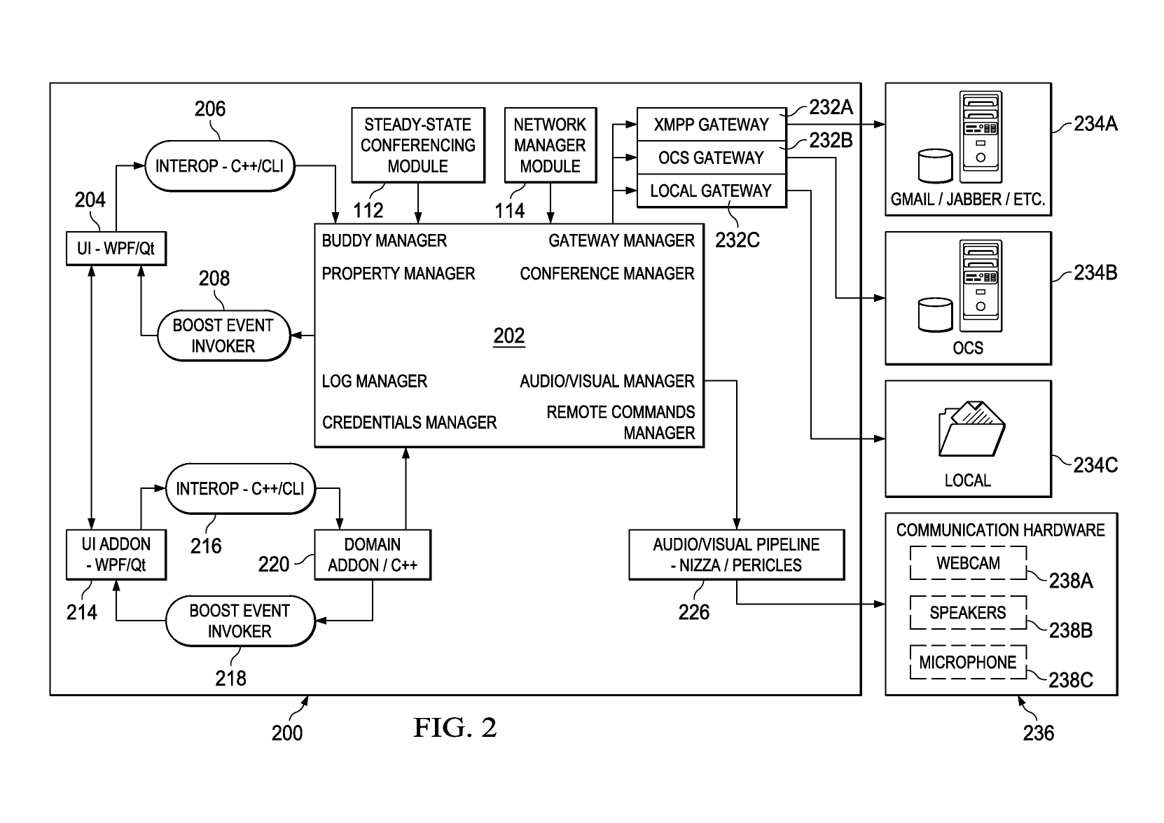

In at least some embodiments, the communication application 110 comprises a plurality of sub-modules (as will be described for FIG. 2) to effectuate a remote conferencing session. As needed, the network manager module 114 notifies at least some sub-modules of the communication application 110 regarding a detected network change. For example, if the “in use” IP address is no longer valid, the network manager module 114 may instruct one or more sub-modules to enter a wait state while network manager module 114 handles the process of determining and selecting a new IP address for use with the communication application 110. If a network change is detected, but the “in use” IP address is still valid, the network manager module 114 may not even notify other communication application sub-modules regarding the network change. In addition to determining whether the “in use” IP address is still valid, the network manager module 114 may determine whether the “in use” IP address is still preferred. If the “in use” IP address is still valid and preferred, the network manager module 114 may not even communicate the network change to the sub-modules. However, if the “in use” IP address is no longer valid or is no longer preferred, the network manager module 114 provides a new “in use” IP address the sub-modules. If needed, the sub-modules may be instructed to enter a wait state while network changes are handled by the network manager module 114.

In summary, if no sub-modules of the communication application 110 are stalled due to a detected network change, the communication application 110 continues its current operation. As an example, the communication application 110 may be using an IP address from a wired connection when a new wireless network is detected. In such case, the communication application 110 continues to use the wired connection even though a change to the IP address table was detected. However, if one or more sub-modules of the communication application 110 are stalled due to a detected network change (i.e., the network change causes errors in the operations of the sub-modules), the detected network change is handled by trapping and/or recovering from errors within each affected sub-module.

As needed, the steady-state conferencing user interface enters a waiting state while network changes are handled by the network manager module 114 or sub-modules of the communication application 110. In the waiting state, media exchanges during the remote conferencing session may be interrupted; however, the presentation of the steady-state conferencing user interface to the conference client is maintained. In some embodiments, the handling of network changes by the network manager module 114 is transparent to a conference client. In alternative embodiments, the network manager module 114 provides information to the steady-state conferencing module 112 to enable the steady-state conferencing user interface to notify the conference client at the computer system 102 regarding network changes and perhaps the expected wait time for recovery. In either case, the presentation of the steady-state conferencing user interface to the conference client is maintained with no subsequent login process (or other conference client action) required to restart or continue a remote conferencing session that has been interrupted by network changes.

In accordance with at least some embodiments, the communication application 110 establishes a peer-to-peer conferencing session between the computer system 102 and a communication endpoint based on “gateway remoting”. As used herein, “gateway remoting” refers to a technique of indirectly populating a contact list of potential conference clients for the communication application 110 and maintaining presence information for these potential conference clients using predetermined contact list and presence information maintained by at least one gateway server.

In order to access a contact list and presence information maintained by a given gateway server, a user at the computer system 102 often logs into the communication service provided by the given gateway server. Although the user could log into each gateway server communication service separately, some embodiments of the communication application 110 enable management of the login process for all gateway service accounts associated with the user of the computer system 102. For example, when a user successfully logs into the communication application 110, all gateway server accounts associated with the user are automatically activated (e.g., by completing a login process for each gateway server account). Additionally or alternatively, contact list information and presence information may be entered manually by via a local gateway connection.

To initiate a remote conferencing session, a user at the computer system 102 selects a conference client from the populated contact list of the communication application 110. The communication application 110 then causes an initial request to be sent to the selected conference client via an appropriate gateway server communication service provided by at least one gateway server. In some cases, there may be more than one appropriate gateway server communication service since the user of the computer system 102 and the selected conference client may be logged into multiple gateway server accounts at the same time. Regardless of the number of appropriate gateway server communication services, the computer system 102 does not yet have direct access to the communication endpoint associated with the selected conference client. After indirectly exchanging connection information (e.g., IP addresses and user names associated with the communication application 110) via a gateway server communication service (e.g., XMPP or Microsoft Office Communication Server 2007), the computer system 102 and the appropriate communication endpoint are able to establish a peer-to-peer conferencing session without further reliance on a gateway server or gateway server communication service. For more information regarding gateway remoting, reference may be had to U.S. application Ser. No. 12/551,273, filed Aug. 31, 2009, and entitled “COMMUNICATION APPLICATION”, which is hereby incorporated herein by reference.

FIG. 2 illustrates various software components of a communication application 200 in accordance with an embodiment of the disclosure. The communication application 200 may correspond, for example, to either of the communication applications 110 and 142 of FIG. 1. As shown, the communication application 200 comprises the steady-state conferencing module 112 and the network manager module 114 described previously for FIG. 1. The communication application 200 also comprises various sub-modules that enable initiation and maintenance of remote conferencing sessions.

More specifically, in the embodiment of FIG. 2, the communication application 200 comprises a management sub-module 202 that supports various management functions of the communication application 200. As shown, the management sub-module 202 supports a “Buddy Manager”, a “Property Manager”, a “Log Manager”, a “Credentials Manager”, a “Gateway Manager”, a “Conference Manager”, an “Audio/Video (A/V) Manager”, and a “Remote Command Manager”.

The Buddy Manager of the management sub-module 202 maintains a contact list of conference clients for the communication application 200. The Property Manager of the management sub-module 202 enables administrative modification of various internal properties of the communication application 200 such as communication bandwidth or other properties. The Gateway Manager of the management sub-module 202 provides an interface for the communication application 200 to communicate with gateway servers 254A-254C. As shown, there may be individual interfaces 232A-232C corresponding to different gateway servers 254A-254C since each gateway server may implement a different protocol. Examples of the interfaces 232A-232C include, but are not limited to, an Extensible Messaging and Presence Protocol (XMPP) interface, an Office Communicator Server (OCS) interface, and a local interface.

Meanwhile, the Conference Manager of the management sub-module 202 handles conferencing session features such as session initiation, time-outs, or other features. The Log Manager of the management sub-module 202 is a debug feature for the communication application. The Credentials Manager of the management sub-module 202 handles login information (e.g., username, password) related to the gateway servers 254A-254C so that an automated login process to the gateway servers 254A-254C is provided by the communication application 200. The A/V Manager of the management sub-module 202 sets up an A/V pipeline to support the conferencing session. The Remote Commands Manager of the management sub-module 202 provides remoting commands that enable the communication endpoint (e.g., the computer system 102) that implements the communication application 200 to send information to and receive information from a remote computer.

As shown, the management sub-module 202 interacts with various other software sub-modules. In at least some embodiments, the management sub-module 202 sends information to and receives information from a user interface (UI) sub-module 204. The UI sub-module 204 may be based on, for example, Windows Presentation Foundation (WPF) or QuickTime (QT). In the embodiment of FIG. 2, the management sub-module 202 sends information to the UI sub-module 204 using a boost event invoker 208 (a C++ feature). On the other hand, the UI sub-module 204 sends information to the management sub-module 202 using a C++ interop (e.g., a Common Language Infrastructure (CLI) interop). To carry out the conferencing session, the management sub-module 202 interacts with an A/V pipeline sub-module 226. In at least some embodiments, the A/V pipeline sub-module 226 is based on Nizza/Pericles software. In operation, the A/V pipeline sub-module 226 discovers, configures (e.g., codec parameters), and sends information to or receives information from communication hardware 236. Examples of communication hardware 236 include, but are not limited to, a web-cam 238A, speakers 238B and a microphone 238C.

In the embodiment of FIG. 2, the UI sub-module 204 and the management sub-module 202 selectively interact with a UI add-on sub-module 214 and a domain add-on sub-module 220. In accordance with at least some embodiments, the “add-on” sub-modules (214 and 220) extend the features of the communication application 200 for remote use without changing the core code. As an example, the add-on sub-modules 214, 220 may correspond to a “desktop sharing” feature that provides the functionality of the communication application 200 at a remote computer. More specifically, the UI add-on sub-module 214 provides some or all of the functions of the UI sub-module 204 for use by a remote computer. Meanwhile, the domain add-on sub-module 220 provides some or all of the functions of the management sub-module 202.

As described previously, the network manager module 114 is able to detect network changes that occur during a conferencing session. As needed, the network manager module 114 notifies at least some sub-modules of the communication application 200 regarding a detected network change. As needed, sub-modules of the communication application 200 enter a waiting state and/or a recovery state until network changes have been handled by the network manager module 114.

Each of the communication applications described herein (e.g., communication applications 110, 142, 200) may correspond to an application that is stored on a computer-readable medium for execution by a processor. When executed by a processor, a communication application causes a processor to detect network changes and to provide steady-state conferencing by selectively handling detected network changes without disrupting a conferencing user interface of the communication application. A communication application, when executed, may further cause a processor to monitor remote network changes for remote clients associated with the communication application. A communication application, when executed, may further cause a processor to monitor local network changes and to broadcast local network updates to remote clients associated with the communication application. A communication application, when executed, may further cause a processor to establish a peer-to-peer conferencing session between at least two communication endpoints based on gateway remoting.

In some embodiments, a communication application, when executed, may further cause a processor to determine if an “in use” IP address associated with the communication application is still valid and still preferred after a detected network change. If so, the communication application does not change its operation. A communication application, when executed, may further cause a processor to consult a list of available IP addresses in response to a network change. If there are no active IP addresses in the list, a steady-state conferencing user interface enters a wait state. A communication application, when executed, may further cause a processor to consult a list of available IP addresses in response to a network change update. If there is an active IP address in the list, the communication application shuts down all active network connections, re-establishes new network connections using the active IP address, and communicates the new network connections to remote clients associated with the communication application.

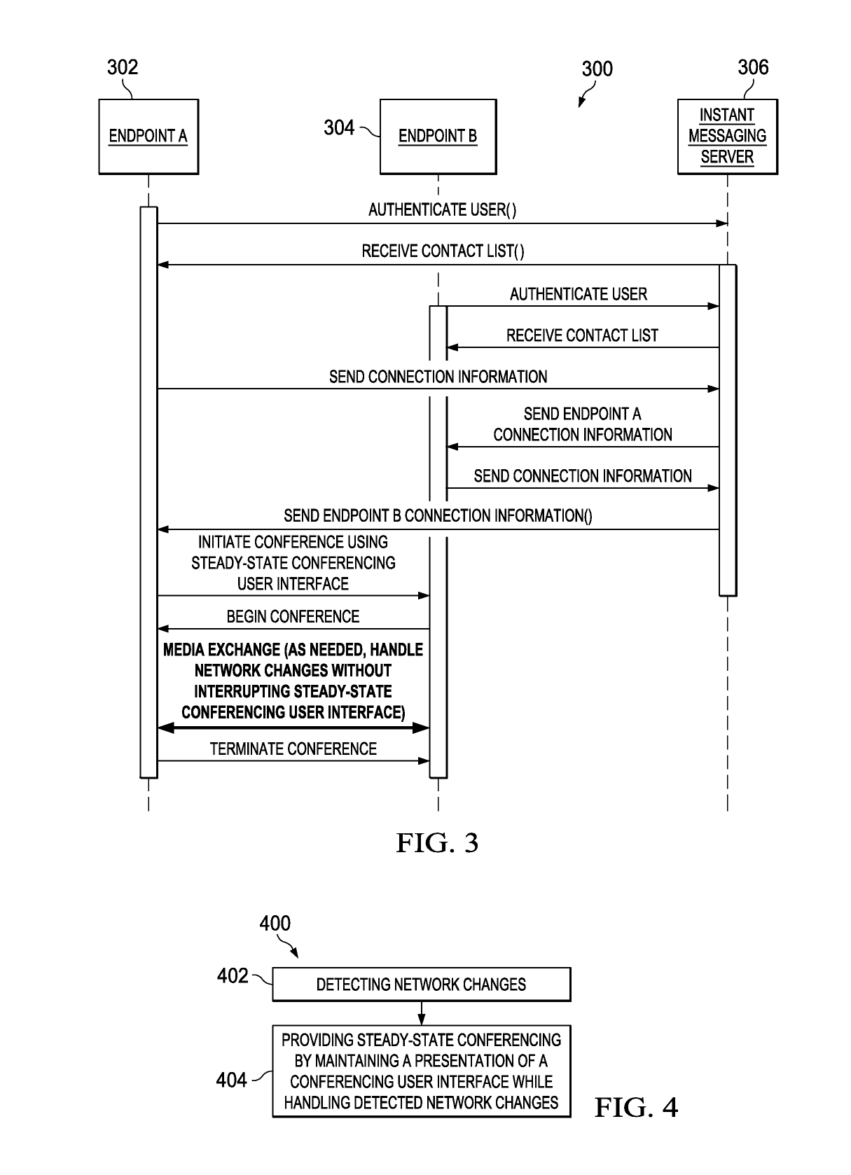

FIG. 3 illustrates a communication technique between two endpoints in accordance with an embodiment of the disclosure. In FIG. 3, the steps begin chronologically at the top (nearest the blocks representing endpoints 302, 304 and instant messaging (IM) server 306) and proceed downward. As shown, the IM server 306 authenticates a user of the endpoint A 302. In response, the endpoint A 302 receives a contact list from the IM server 306. Next, the IM server 306 authenticates a user of the endpoint B 304. In response, the endpoint B 304 receives a contact list from the IM server 306. Based on the contact list from the IM server 306, endpoint A 302 sends connection information to the IM server 306, which forwards endpoint A connection information to the endpoint B 304. Similarly, endpoint B 304 sends connection information to the IM server 306, which forwards endpoint B connection information to the endpoint A 302. In other words, the endpoint A 302 and the endpoint B 304 exchange primary connection information via the IM server 306. Subsequently, the endpoint A 302 is able to initiate a conference with endpoint B 304 using a steady-state conferencing user interface. Upon a successful response from the endpoint B 304 (e.g., a user of endpoint B 304 accepts a request to participate in a remote conferencing session with a user of endpoint A 302), a media exchange occurs. As needed, network changes are handled during the media exchange without interrupting the steady-state conferencing user interface. The media exchange may be audio, video, still images, and/or text. Eventually, the conference terminates.

FIG. 4 illustrates a method 400 in accordance with embodiments of the disclosure. As shown, the method 400 comprises a detecting network changes (block 402). The method 400 further comprises providing steady-state conferencing by maintaining a presentation of a conferencing user interface while handling detected network changes (block 404). The method 400 may comprise additional steps that are added individually or in combination. As an example, the method 400 may additionally comprise responding to network change broadcasts received from remote clients associated with the communication application and broadcasting local network changes to remote clients associated with the communication application. The method 400 may additionally comprise establishing a peer-to-peer conferencing session between a plurality of communication endpoints based on gateway remoting. The method 400 may additionally comprise determining if an “in use” Internet Protocol (IP) address associated with the communication application is still valid and still preferred after a detected network change and, if so, maintaining an operation of the communication application. The method 400 may additionally comprise consulting a list of available Internet Protocol (IP) addresses in response to a network change update. If there are no active IP addresses in the list, the method 400 may comprise causing the conferencing user interface to enter a wait state. If there is an active IP address in the list, the method 400 may comprise re-establishing new network connections using the active IP address and broadcasting the new network connections to remote clients associated with the communication application.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
a processor;
a network interface coupled to the processor; and
a system memory coupled to the processor, the system memory storing a communication application having a steady-state conferencing module and a network manager module,
wherein the network manager module, when executed, monitors network changes,
wherein the steady-state conferencing module, when executed, maintains a steady-state conferencing user interface while network changes detected by the network manager module are handled.

2. The computer system of claim 1 wherein the network manager module monitors remote network changes via the network interface, the remote network changes being received from remote clients associated with the communication application.

3. The computer system of claim 1 wherein the network manager module monitors local network changes and selectively broadcasts local network updates via the network interface to remote clients associated with the communication application.

4. The computer system of claim 1 wherein the communication application establishes a peer-to-peer conferencing session between the computer system and a communication endpoint based on gateway remoting.

5. The computer system of claim 1 wherein, in response to a network change notification from the network manager module, a sub-module of the communication application determines if an “in use” Internet Protocol (IP) address associated with the communication application is still valid and, if so, the sub-module does not change its operation.

6. The computer system of claim 5 wherein, in response to determining that the “in use” IP address is still valid, the sub-module determines if the “in use” IP address is still preferred and, if not, the sub-module changes its operation.

7. The computer system of claim 1 wherein, in response to a network change notification from the network manager module, a sub-module of the communication application consults a list of available Internet Protocol (IP) addresses and, if there are no active IP addresses in said list, the sub-module enters a wait state.

8. The computer system of claim 1 wherein, in response to a network change notification from the network manager module, a sub-module of the communication application consults a list of available Internet Protocol (IP) addresses and, if there is an active IP address in said list, the sub-module shuts down all active network connections, re-establishes new network connections using said active IP address, and communicates the new network connections to remote clients associated with the communication application.

9. A computer-readable storage medium storing a communication application that, when executed, causes a processor to:
detect network changes; and
provide steady-state conferencing by selectively handling detected network changes without disrupting a conferencing user interface of the communication application.

10. The computer-readable storage medium of claim 9 wherein the communication application, when executed, causes the processor to monitor remote network changes for remote clients associated with the communication application.

11. The computer-readable storage medium of claim 9 wherein the communication application, when executed, causes the processor to monitor local network changes and to broadcast local network updates to remote clients associated with the communication application.

12. The computer-readable storage medium of claim 9 wherein the communication application, when executed, causes the processor to establish a peer-to-peer conferencing session between at least two communication endpoints based on gateway remoting.

13. The computer-readable storage medium of claim 9 wherein the communication application, when executed, causes the processor to determine if an “in use” Internet Protocol (IP) address associated with the communication application is still valid and still preferred after a detected network change and, if so, the communication application does not change its operation.

14. The computer-readable storage medium of claim 9 wherein the communication application, when executed, causes the processor to consult a list of available Internet Protocol (IP) addresses in response to a network change update and, if there are no active IP addresses in said list, the conferencing user interface enters a wait state.

15. The computer-readable storage medium of claim 9 wherein the communication application, when executed, causes the processor to consult a list of available Internet Protocol (IP) addresses in response to a network change update and, if there is an active IP address in said list, the communication application shuts down all active network connections, re-establishes new network connections using said active IP address, and communicates the new network connections to remote clients associated with the communication application.

16. A method for a communication application, comprising:
detecting network changes; and
providing steady-state conferencing by maintaining a presentation of a conferencing user interface while handling detected network changes.

17. The method of claim 16 further comprising responding to network change broadcasts received from remote clients associated with the communication application and broadcasting local network changes to remote clients associated with the communication application.

18. The method of 16 further comprising establishing a peer-to-peer conferencing session between a plurality of communication endpoints based on gateway remoting.

19. The method of claim 16 further comprising determining if an “in use” Internet Protocol (IP) address associated with the communication application is still valid and still preferred after a detected network change and, if so, maintaining an operation of the communication application.

20. The method of claim 16 further comprising:
consulting a list of available Internet Protocol (IP) addresses in response to a network change update;
if there are no active IP addresses in said list, causing the conferencing user interface to enter a wait state; and
if there is an active IP address in said list, re-establishing new network connections using said active IP address and broadcasting the new network connections to remote clients associated with the communication application.
